(19) United States
(12) Patent Application Publication
(10) Pub. No.: US 2023/0002200 A1
(43) Pub. Date: Jan. 5, 2023

(54) Spreader Structures for Lifting Loads

(71) Applicant: Subsea 7 Limited, Sutton (GB)

(72) Inventor: Sabesan Rajaratnam, Wallington (GB)

(21) Appl. No.: 17/781,359

(22) PCT Filed: Dec. 1, 2020
(86) PCT No.: PCT/GB2020/053079

§ 371 Date: May 31, 2022

(30) Foreign Application Priority Data
Dec. 3, 2019 (GB) 1917657.7

(51) Int. Cl. B66C 1/22; B63B 27/30

(52) U.S. Cl. CPC B66C 1/22; B63B 27/30

(57) ABSTRACT

A modular spreader structure (10) for use in offshore lifts comprises a plurality of elongate tubular elements (26, 22) made primarily of composite material. Primary tubular elements (26) each comprise an axial coupler formation (28) for end-to-end coupling with a complementary axial coupler formation of another primary tubular element, aligned on a common longitudinal axis. The adjoining primary tubular elements are interengageable by longitudinal overlap between male and female axial coupler formations. Secondary tubular elements (22) each comprise a node connector (30) that is configured for attachment to the structure at an orientation inclined relative to the common longitudinal axis of the primary tubular elements. In particular, the secondary tubular elements can be attached to an outer surface of one of the primary tubular elements.

This invention relates to lifting systems, particularly those used for lifting bulky loads offshore. Common examples of such loads are rigid jumper pipes or spool pipes, which effect fluid connections in hydrocarbon production installations as used in the subsea oil and gas industry.

When being transported and installed, a jumper pipe or spool pipe, including its heavy end connectors, must be lifted onto and off an installation vessel and then from the vessel down through the water column to the seabed. Whilst nominally rigid, the pipe will tend to bend along its length under the loads of self-weight and installation. The pipe must therefore be supported carefully during transportation and installation so as to avoid plastic deformation.

The invention is particularly concerned with spreader structures such as spreader bars and spreader frames. Spreader bars are used to lift relatively light loads, typically of up to 50 tonnes, and loads with relatively simple, largely two-dimensional shapes that lie substantially in an upright plane. Conversely, spreader frames are used to lift relatively heavy loads, typically of up to 150 tonnes or more, and loads with relatively complex, substantially non-planar, more three-dimensional shapes.

In general, spreader structures are apt to be used as installation aids for transporting, lifting and installing elongate loads that may have complex shapes. They provide appropriate location points to which the load is attached or from which the load is suspended. By doing so, spreader structures maintain equilibrium and support the load at multiple points along its length so as to minimise stress.

Thus, spreader structures provide an interface between a load and a crane. Specifically, the crane typically suspends a spreader structure from a set of upper ropes or slings. The spreader structure, in turn, supports or suspends the load, for example from a set of lower ropes or slings.

Consequently, the crane lifts the spreader structure and the load together, meaning that the weight of the spreader structure reduces the effective lifting capacity of the crane. Typically, however, spreader structures are fabricated from steel. This makes them heavy, and so significantly increases the aggregate weight that has to be lifted by the crane.

An oversized standard spreader frame may be used for onshore lifts, for example in ports where large-capacity cranes are readily available. In that case, ropes or slings may be attached to the frame at various locations to comply with the size and shape of the load to be lifted. However an oversized spreader frame may be unsuitable for offshore lifting, where the capacity of an available crane is likely to be much more limited.

In another approach, a spreader structure may be modified for each specialised lift. This is less convenient where there are time constraints and where space and weight are constrained by the working deck of the vessel.

The bulkier and more complex the load, the more likely it is that a matching spreader structure will have to be designed and fabricated for that particular load on a bespoke, one-off basis. In that case, the spreader structure may have to be scrapped after just a single use. This is exceedingly wasteful, not just of materials but also of design and manufacturing resources.

In use, spreader structures may be subjected to various potentially damaging influences, namely: large lifting loads, which can give rise to compression and bending stresses; fatigue and impact loads; significant temperature variations; degradation due to the marine environment; and substantial hydrostatic pressure if the structure comprises sealed hollow members that are not flooded. Even where a spreader structure is apt to be used offshore more than once, these influences militate against its repeated long-term use. For example, the spreader structure may suffer from corrosion or fatigue with prolonged or repeated use. In any event, it may be challenging to provide a suitable place to store such a large structure that is in merely intermittent use.

Spreader bars that can be adjusted by telescoping beams or tubes are described in U.S. Pat. No. 7,222,903. However, the practical usefulness of this solution is limited by a requirement for case-by-case recertification of non-standard heavy-lift equipment for use offshore. WO 98/12455 discloses another example of an adjustable spreader bar system.

Modular lattice spreader frames of steel are also known, for example as sold by Modulift UK Ltd under the trade mark ‘Modulift’. In this example, steel tubes with end flanges are connected together by coupling the flanges.

To reduce weight, tubular members of thermoplastic composites have been used or proposed for various structural applications as an alternative to steel. However, flanges of composite material are more sensitive to shear stresses than flanges of steel.

Tubular members can instead be connected by fitting together their facing ends telescopically in male/female relation. For example, EP 0415012 discloses a conical coupler between pipes that may be of metals or plastics. However, that arrangement is not capable of withstanding large structural loads, especially in tension. Tapered pipe joints or spigots are also taught in U.S. Pat. No. 3,567,257, but only in the context of a soldered or brazed joint between a pipe and a fitting.

US 2019/002246 A1 discloses the use of bars, joined together by lugs and pins, to be used in spreader bar assembly configurations, while CN 208829096 U describes a sectional lifting beam to be used in the joint operation of two cranes. End sections of the beam comprise lugs that can attach to each crane and the sectional beam can be fitted with a hook section to enable further connections. Middle beam sections of varying lengths can be positioned between the end sections and hook sections, with all sections being connected through the use of flanges and pins.

Against this background, the invention resides in a modular spreader structure for use in offshore lifts. The structure comprises a plurality of elongate primary tubular elements made primarily of composite material. Each primary tubular element comprises an axial coupler formation for end-to-end coupling with a complementary axial coupler formation of another primary tubular element of the structure, aligned on a common longitudinal axis.

For example, an axial coupler formation of at least one of the tubular elements may comprise a male formation, which may taper distally. The male formation may be surrounded by a distally-facing shoulder. Similarly, an axial coupler formation of at least one of the primary tubular elements may comprise a complementary female formation, which may taper proximally. The female formation may be surrounded by a distally-facing flange that abuts the shoulder when the formations brought together into full mutual engagement.

The axial coupler formation of each primary tubular element suitably extends distally from, or within, a radially-enlarged portion of the tubular element that has locally-increased wall thickness.

Adjoining primary tubular elements are preferably interengageable by virtue of longitudinal overlap between their axial coupler formations. In that case, the tubular elements may be locked together by at least one locking pin that extends through mutually-aligned transverse bores in the axial coupler formations. To ensure angular alignment for this purpose, an alignment key in at least one of the axial coupler formations may be cooperable with an opposed notch in another of the axial coupler formations.

Advantageously, the axial coupler formations may be covered by a protective cover or liner of a stiffer or more wear-resistant material than the composite material, such as of steel.

At least one of the primary tubular elements may comprise an external stopper formation such as a ridge that extends circumferentially around that primary tubular element.

The structure of the invention may further comprise at least one secondary elongate tubular element that is also made primarily of composite material. The secondary tubular element has a node connector that is configured to attach the secondary tubular element to the structure at an orientation that intersects or is inclined relative to the common longitudinal axis of the primary tubular elements.

The node connector may be integral with the secondary tubular element or may be joined to the secondary tubular element, for example by additional axial coupler formations like those used to join together successive primary tubular elements.

In examples to be described, the node connector may be configured to attach the secondary tubular element to an outer surface of one of the primary tubular elements. For this purpose, the node connector suitably comprises at least one jaw with a distal end face that has curvature complementary to the outer surface of that primary tubular element.

The distal end face of the or each jaw is preferably curved about an axis of curvature that is substantially aligned with a central longitudinal axis of the secondary tubular element. The axis of curvature may also be substantially orthogonal to the central longitudinal axis of the secondary tubular element. Also, the distal end face of the or each jaw may comprise a recess or other formation that is engageable with an external stopper formation of at least one of the primary tubular elements.

The or each jaw is preferably made from a composite material that is integral with the composite material of the secondary tubular element. In that case, the or each jaw may further comprise an insert of steel or other more rigid material than the composite material of the jaw.

At least two external stopper formations may be spaced apart longitudinally along a primary tubular element, in which case the node connector may be engaged with that primary tubular element between those external stopper formations.

The structure of the invention may further comprise attachment points for suspending the structure from a lifting point and for suspending a load from the structure.

The inventive concept also embraces a corresponding method of assembling a spreader structure, made primarily of composite material, for use in an offshore lift. The method comprises interengaging elongate primary tubular elements end-to-end in mutual alignment on a common longitudinal axis by virtue of longitudinal overlap between axial coupler formations of the primary tubular elements.

At least one elongate secondary tubular element may be attached to the primary tubular elements, for example by being attached to an outer surface of at least one of the primary tubular elements. In that case, the or each secondary tubular element may be engaged or abutted with at least one stopper formation on the outer surface of at least one of the primary tubular elements.

The method of the invention may further comprise disassembling the spreader structure and then reassembling the spreader structure at a different installation site or in a different configuration. Advantageously, the tubular elements may be placed into a standard shipping container for storage or transportation after disassembly of the spreader structure. For this purpose, it is beneficial that no part of the structure is of more than 12 m in length when disassembled.

Embodiments of the invention provide a lightweight modular spreader structure for offshore lifts that comprises several tubes of thermoplastic composite material, each tube being hollow and having two ends, each end being either an axial coupler or a node connector.

An axial coupler may be either a male coupler or a female coupler, and suitably comprises a hard cover or insert, for example of steel, to protect the contact interface between adjoining tubes. Two such couplers may overlap each other longitudinally.

The interface between adjoining tubes may be tapered. The interface may comprise at least one key or a groove to engage a key of a connecting tube.

An axial connector may be formed by coupling a male coupler and a female coupler. The axial connector may then be secured by inserting a transverse pin through bores of the two couplers.

A node connector may, for example, comprise at least one half clamp, to connect to a second half clamp that mounts around a perpendicular tube, or a flange assembly to mount a clamping means. The node connector may be integral to the tube or may be connected to an axial coupler.

The outer surface of a tube may comprise at least one stopper rim or other formation for stopping a clamp or collar.

Advantageously, the tubes may be no more than 12 m (40 feet) long so that they can be stored and transported in standard shipping containers.

The composite modular spreader bar or frame of the invention offers various advantages compared to spreader structures of steel, such as: reusability; recyclability; light weight, noting that polymer composite material may have a density of about 20% of the density of steel; an excellent ratio of weight to rigidity and toughness; good mechanical, thermal and chemical properties; excellent corrosion resistance; and high fatigue capacity.

In view of these beneficial properties, a spreader bar or frame of the invention can be designed to suit long-term repeat usage over several successive projects, for example over a period of 25 years. This gives rise to significant cost savings in the long term and minimises environmental impact, with no need for scrapping after each project and with the possibility of recycling at the end of its life.

A spreader bar or frame of the invention can be made from multiple sections. The sections may be joined together to make spreader bars of different lengths based on the project requirement. The sections can be disassembled after use for compact storage and easy transportation before eventual re-use, potentially to make a spreader structure of a different size or shape to that used previously.

In summary, the invention provides modular spreader structure for use in offshore lifts that comprises a plurality of elongate tubular elements made primarily of composite material. Primary tubular elements each comprise an axial coupler formation for end-to-end coupling with a complementary axial coupler formation of another primary tubular element, aligned on a common longitudinal axis. The adjoining primary tubular elements may be interengageable by longitudinal overlap between male and female axial coupler formations.

Secondary tubular elements may each comprise a node connector that is configured for attachment to the structure at an orientation inclined relative to the common longitudinal axis of the primary tubular elements. Thus, the secondary tubular elements can be attached to an outer surface of one of the primary tubular elements.

In order that the invention may be more readily understood, reference will now be made, by way of example, to the accompanying drawings in which:

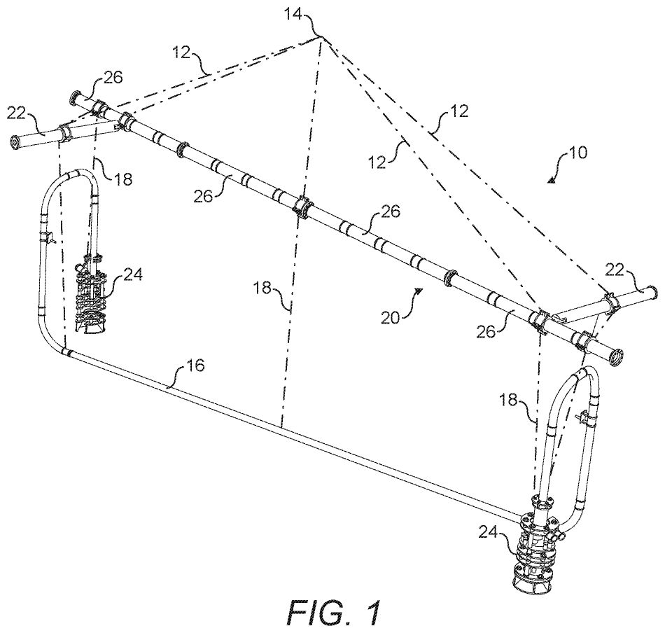

FIG. 1 is a perspective view of a spreader structure of the invention in use supporting a jumper pipe;

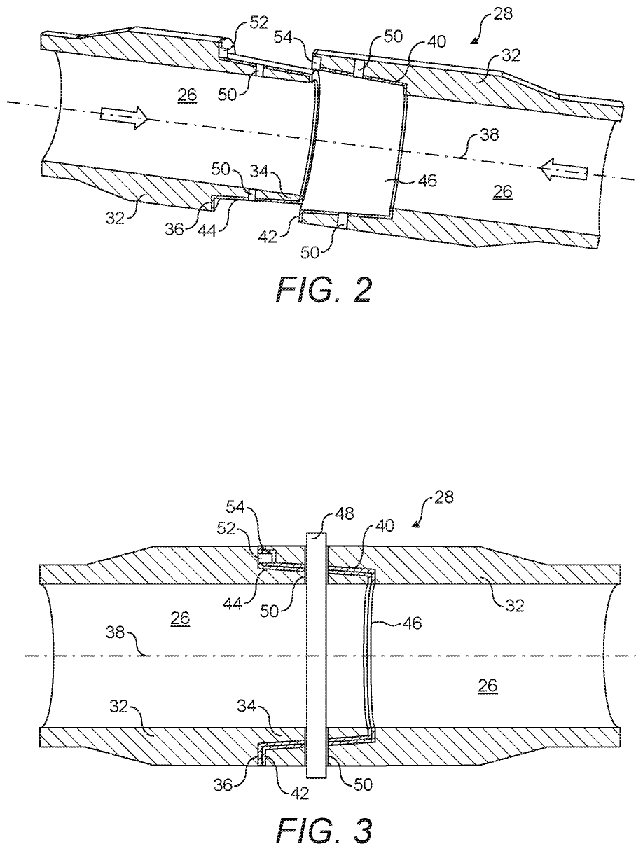

FIG. 2 is a perspective view in longitudinal section of an axial coupler interface between adjoining tubular elements of the spreader structure shown in FIG. 1, in the process of assembly;

FIG. 3 is a longitudinal sectional view of the interface shown in FIG. 2, when assembled;

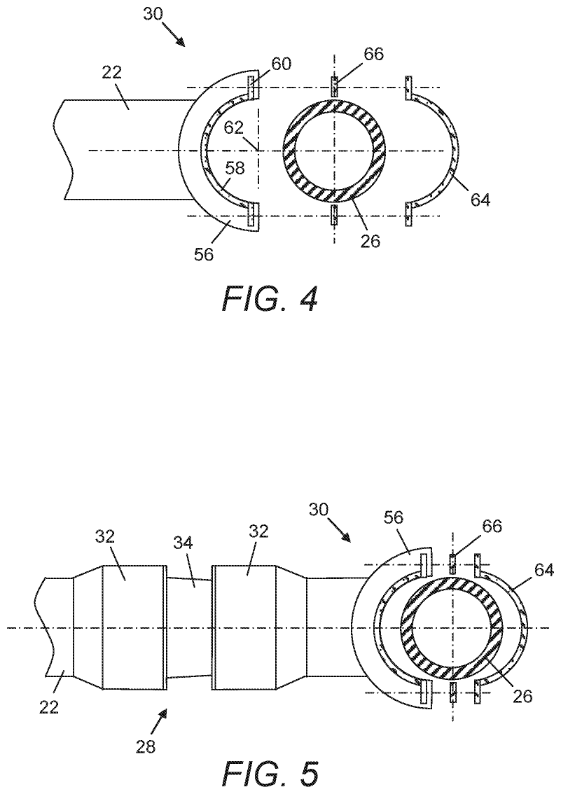

FIG. 4 is an exploded part-sectional side view of a node connector joining perpendicular tubes of the spreader structure shown in FIG. 1;

FIG. 5 is a part-sectional side view of a variant of the node connector shown in FIG. 4;

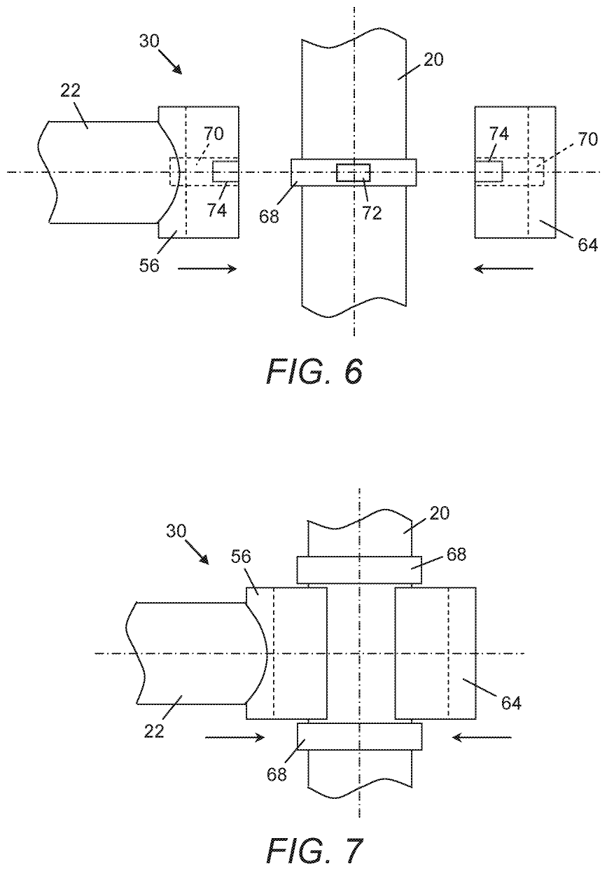

FIG. 6 is an exploded top view of another variant of the node connector, showing a stopper arrangement; and

FIG. 7 is a top view of another node connector, showing a variant of the stopper arrangement shown in FIG. 6.

Referring firstly to FIG. 1 of the drawings, a spreader structure 10 of the invention is shown here suspended by upper slings 12 that radiate outwardly and downwardly from a lifting point 14 such as a hook of a crane (not shown). The spreader structure 10 supports a jumper pipe 16 via a set of lower slings 18. The upper and lower slings 12, 18 are represented here schematically by dotted lines.

In this example, the spreader structure 10 comprises an elongate, substantially straight and substantially horizontal spreader bar 20. The spreader structure 10 further comprises outrigger tubes 22 that extend in opposite directions orthogonally and substantially horizontally from respective junctions that are close to respective ends of the spreader bar 20. The outrigger tubes 22 provide additional support to the heavy and bulky end connectors 24 of the jumper pipe 16, which depart from the otherwise substantially upright plane of the central portion of the jumper pipe 16.

Conveniently, at least some of the upper and lower slings 12, 18 are attached to the spreader structure at junctions between the spreader bar 20 and the outrigger tubes 22.

The spreader bar 20 comprises a longitudinal series of tubular sections or elements 26 that are joined together end-to-end. Here, the spreader bar 20 is an assembly that comprises a series of four elongate tubular elements 26, each element 26 being 12 m in length for example.

The tubular elements 26 of the spreader bar 20 and the outrigger tubes 22 are each made primarily of a fibre-reinforced polymer composite material, preferably comprising a matrix of thermoplastics. More generally, the tubular elements 26 and the outrigger tubes 22 may be made of an elastomeric or polymeric matrix, embedding unidirectional or multidirectional reinforcements.

The interface defining the joint between each successive pair of tubular elements 26 is defined by an axial coupler 28 as exemplified in FIGS. 2 and 3. The interface defining the junction between each outrigger tube 22 and the spreader bar 20 is defined by a node connector 30 like those exemplified in FIGS. 4 to 7.

Turning next, then, to FIGS. 2 and 3, the axial coupler 28 comprises radially-enlarged facing end portions 32 of the polymer composite tubular elements 26. The local wall thickness of the tubular elements 26 is increased at these end portions 32 and then decreases distally to form complementary, tapering axially-engageable male and female formations.

One of the facing end portions 32 is a male coupler that comprises a distally-tapering, frusto-conical protrusion or spigot 34. The spigot 34 is concentric with a surrounding circumferential shoulder 36 that lies in a plane orthogonal to the central longitudinal axis 38 of the tubular element 26.

The other of the facing end portions 32 is a female coupler that comprises a proximally-tapering, frusto-conical recess or socket 40 whose shape corresponds to and complements the spigot 34 of the male coupler. The socket 40 is concentric with a surrounding circumferential flange 42 that lies in a plane orthogonal to the central longitudinal axis 38 of the tubular element 26.

The spigot 34 and the surrounding shoulder 36 are faced by a steel cover layer 44. Similarly, the socket 40 and the surrounding flange 42 are faced by a complementary steel liner layer 46. The cover layer 44 and the liner layer 46 are each bonded to the underlying polymer composite material of the tubular elements 26 so as to reinforce and protect that material.

When the spigot 34 of the male coupler is fully inserted into the socket 40 of the female coupler as shown in FIG. 3, the cover layer 44 of the spigot 34 engages closely against and within the liner layer 46 of the socket 40. Similarly, the shoulder 36 of the male coupler bears against the flange 42 of the female coupler via the cover layer 44 and the liner layer 46.

Once fully inter-engaged in this way, the male and female couplers are preferably locked together by a transverse pin 48 as also shown in FIG. 3. The pin 48 extends through longitudinally- and angularly-aligned holes 50 that penetrate the tapering tubular walls of the spigot 34 and the socket 40 and also extend through the associated cover and liner layers 44, 46.

Longitudinal alignment of the holes 50 is assured by abutment between the shoulder 36 and the flange 42 upon full engagement between the male and female couplers. Conversely, angular alignment between the holes 50 is assured by alignment of, and engagement between, a key formation 52 projecting from the shoulder 36 of the male coupler and a complementary notch 54 in the opposed flange 42 of the female coupler.

Moving on to FIGS. 4 to 7, these drawings show various node connectors 30 of the invention. The simplest of these node connectors 30 is shown in FIG. 4 and comprises a jaw formation 56 at an end of an outrigger tube 22. The jaw formation 56 is of thermoplastic composite material and is conveniently formed integrally with the composite wall of the outrigger tube 22. The concave-curved distal end face 58 of the jaw formation 56 is faced by, or reinforced with, an embedded steel insert layer 60 to protect or strengthen the composite material.

The distal end face 58 of the jaw formation 56 is part-circular in longitudinal section, with a substantially constant radius of curvature. The radius of curvature is centred on an axis of curvature 62 that is orthogonal to, and intersected by, the central longitudinal axis of the outrigger tube 22. The radius of curvature of the distal end face 58 corresponds to the outer radius of the spreader bar 20. Thus, when the outrigger tube 22 is assembled with the spreader bar 20 such that the central longitudinal axis 38 of the spreader bar 20 lies on the axis of curvature 62 of the distal end face, a tubular element 26 of the spreader bar 20 is received snugly in the jaw formation 56.

The jaw formation 56 is held in engagement with the spreader bar 20 by an oppositely-curved jaw element 64 of steel. Thus, the jaw formation 56 and the jaw element 64 cooperate with each other in the manner of half-shells. The jaw element 64 is suitably bolted to the jaw formation 56 via washers 66 and may thereby deform resiliently to apply clamping force to the spreader bar 20.

In the variant of FIG. 5, the jaw formation 56 of the node connector 30 is not integral with an outrigger tube 22 but is instead coupled to an end of an outrigger tube 22 by an axial coupler 28 like that of FIGS. 2 and 3, shown here in a partially-engaged state. Like numerals are used for like features of the axial coupler 28, and so need not be described further here.

Frictional engagement between the spreader bar 20 and the jaw formation 56 of a node connector 30 may be sufficient to keep an outrigger tube 22 in fixed relation to the spreader bar 20. However, the spreader bar 20 and the jaw formation 56 may additionally, or instead, be connected to each other by mechanical engagement. FIGS. 6 and 7 show arrangements for the node connector 30 that effect mechanical engagement between these parts.

In FIG. 6, the spreader bar 20 is encircled by a circumferential stopper ridge 68 that is received in complementary grooves 70 provided in the concave faces of the jaw formation 56 and the opposed jaw element 64. The stopper ridge 68 may be formed integrally with a tubular element 26 of the spreader bar 20 by locally increasing the wall thickness of the tubular element 26, or may be bonded or otherwise attached to the tubular element 26.

When the spreader bar 20 is clamped between the jaw formation 56 and the jaw element 64, engagement between the stopper ridge 68 and the grooves 70 prevents the node connector 30 and the outrigger tube 22 sliding along the spreader bar 20. Moreover, the spreader bar 20 has one or more key formations 72, conveniently formed integrally with the stopper ridge 68, that engage with one or more complementary recesses 74 of the jaw formation 56 and/or the jaw element 64. Engagement of the or each key formation 72 with the or each recess 74 prevents the node connector 30 and the outrigger tube 22 pivoting or swinging about the spreader bar 20.

Finally, in FIG. 7, the spreader bar 20 is encircled by a pair of circumferential stopper ridges 68 that are spaced apart longitudinally. The jaw formation 56 and the jaw element 64 are clamped together around the spreader bar 20 in the space between the stopper ridges 68. The stopper ridges 68 thereby prevent the node connector 30 and the outrigger tube 22 sliding beyond them along the spreader bar 20.

Many variations are possible within the inventive concept. For example, the jaw formations 56 of the node connectors 30 shown in FIGS. 6 and 7 need not be integral with the outrigger tube 22 but may instead be coupled to an end of an outrigger tube 22 by an axial coupler 28 like that of FIGS. 2 and 3.

The principles of the invention may be used to construct spreader structures of various shapes or sizes, including box-section or triangulated lattices that may comprise diagonal braces. Consequently, it is not essential that adjoining tubular members of the spreader structure are in mutually orthogonal relation. It would instead be possible for adjoining members of the structure to be at angles of greater or less than 90° relative to each other. Thus, the axis of curvature of a jaw formation may lie at any required angle relative to the central longitudinal axis of a tubular member that carries the jaw formation.

The cover layer, liner layer and insert layer need not be of steel but could instead be of other metals or of other suitably robust materials.

The length of at least some of the tubular members of the spreader structure may be adjustable, for example by a telescoping action.

At least some of the tubular members of a spreader structure such as a spreader bar or an outrigger tube may support lift clamps. Each lift clamp may, for example, comprise a sleeve that encircles the supporting member and may have a frictionless design so as to pivot freely around that member. In that case, unwanted sliding of a lift clamp along a member of the spreader structure may be resisted by stopper arrangements like those shown in FIGS. 6 and 7.

Whilst the drawings show the outrigger tubes as being of substantially the same outer diameter as the tubular elements of the spreader bar, the outrigger tubes and the tubular elements could instead have different outer diameters.

1. A modular spreader structure for use in offshore lifts, the structure comprising a plurality of elongate primary tubular elements made primarily of composite material, wherein each primary tubular element comprises an axial coupler formation for end-to-end coupling with a complementary axial coupler formation of another primary tubular element of the structure aligned on a common longitudinal axis.

2. The structure of claim 1, wherein the axial coupler formation of at least one of the tubular elements comprises a male formation.

3. The structure of claim 2, wherein the male formation tapers distally.

4. The structure of claim 2 or claim 3, wherein the male formation is surrounded by a distally-facing shoulder.

5. The structure of any of claims 2 to 4, wherein the axial coupler formation of at least one of the primary tubular elements comprises a complementary female formation.

6. The structure of claim 5, wherein the female formation tapers proximally.

7. The structure of claim 5 or claim 6, wherein the female formation is surrounded by a distally-facing flange.

8. The structure of any preceding claim, wherein the axial coupler formation of each primary tubular element extends distally from a radially-enlarged portion of the tubular element that has locally-increased wall thickness.

9. The structure of any preceding claim, wherein adjoining primary tubular elements are interengageable by longitudinal overlap between their axial coupler formations.

10. The structure of claim 9, further comprising at least one locking pin extending through mutually-aligned transverse bores in the axial coupler formations.

11. The structure of claim 10, further comprising an alignment key in at least one of the axial coupler formations, cooperable with an opposed notch in another of the axial coupler formations.

12. The structure of any preceding claim, wherein the axial coupler formations are covered by a protective cover or liner of a stiffer material than the composite material.

13. The structure of claim 12, wherein the protective cover or liner is of steel.

14. The structure of any preceding claim, wherein at least one of the primary tubular elements comprises an external stopper formation.

15. The structure of claim 14, wherein the stopper formation is a ridge extending circumferentially around said primary tubular element.

16. The structure of any preceding claim, further comprising at least one secondary elongate tubular element made primarily of composite material, the secondary tubular element having a node connector that is configured to attach the secondary tubular element to the structure at an orientation inclined relative to the common longitudinal axis of the primary tubular elements.

17. The structure of any preceding claim, wherein the node connector is configured to attach the secondary tubular element to an outer surface of one of the primary tubular elements.

18. The structure of claim 17, wherein the node connector comprises at least one jaw with a distal end face that has curvature complementary to the outer surface of said primary tubular element.

19. The structure of claim 18, wherein the distal end face of the or each jaw is curved about an axis of curvature that is substantially aligned with a central longitudinal axis of the secondary tubular element.

20. The structure of claim 19, wherein the axis of curvature is substantially orthogonal to the central longitudinal axis of the secondary tubular element.

21. The structure of any of claims 18 to 20, wherein the or each jaw is made from a composite material that is integral with the composite material of the secondary tubular element.

22. The structure of claim 21, wherein the or each jaw further comprises an insert of a stiffer material than the composite material of the jaw.

23. The structure of any of claims 18 to 22, wherein the distal end face of the or each jaw comprises a recess that is engageable with an external stopper formation of at least one of the primary tubular elements.

24. The structure of any of claims 18 to 22, wherein at least two external stopper formations are spaced apart longitudinally along a primary tubular element and the node connector is engageable with that primary tubular element between those external stopper formations.

25. The structure of any of claims 16 to 24, wherein the node connector is joined to the secondary tubular element by additional axial coupler formations.

26. The structure of any preceding claim, wherein no part of the structure is of more than 12 m in length when disassembled.

27. The structure of any preceding claim, further comprising attachment points for suspending the structure from a lifting point and for suspending a load from the structure.

28. A method of assembling a spreader structure, made primarily of composite material, for use in an offshore lift, the method comprising interengaging elongate primary tubular elements end-to-end in mutual alignment on a common longitudinal axis by virtue of longitudinal overlap between axial coupler formations of the primary tubular elements.

29. The method of claim 28, comprising locking together the primary tubular elements by extending at least one locking pin through mutually-aligned transverse bores in the overlapping axial coupler formations.

30. The method of claim 28 or claim 29, further comprising attaching at least one elongate secondary tubular element to the primary tubular elements at an orientation that is inclined relative to the common longitudinal axis of the primary tubular elements.

31. The method of claim 30, comprising attaching the or each secondary tubular element to an outer surface of at least one of the primary tubular elements.

32. The method of claim 31, comprising engaging or abutting the or each secondary tubular element with at least one stopper formation on the outer surface of at least one of the primary tubular elements.

33. The method of any of claims 28 to 32, further comprising disassembling the spreader structure and reassembling the spreader structure at a different installation site or in a different configuration.

34. The method of claim 33, comprising placing the tubular elements into a standard shipping container for storage or transportation after disassembly of the spreader structure.
